(19) United States
(12) Patent Application Publication
(10) Pub. No.: US 2005/0121971 A1
(43) Pub. Date: Jun. 9, 2005

(54) Serial train communication system

(76) Inventor: Michael E. Ring, Saint John, IN (US)

Correspondence Address: JAMES RAY & ASSOCIATES, 2640 Pitcairn Road, Monroeville, PA, 15146, US

(21) Appl. No.: 11/000,850

(22) Filed: Dec. 1, 2004

Related U.S. Application Data
(60) Provisional application No. 60/527,505, filed on Dec. 5, 2003.

(51) Int. Cl. B60T 13/00

(52) U.S. Cl. 303/7

(57) ABSTRACT

A serial train communication system employs a pair of ultrasonic transceivers oppositely mounted at each end of a railway car. Each ultrasonic transceiver is coupled to a controller and to an independent power source. The controller is further coupled to various apparatuses installed on the railway car and is capable of controlling operation thereof. A command signal sent from a locomotive cab travels between railway cars enabling control of various apparatuses of such railway cars and status signals from such apparatuses may be sent back to a locomotive cab event recorder. The controller and the power source may be attached to the railway car or to any such apparatus. In another embodiment, a single ultrasonic transceiver is installed within an air brake pipe enabling communication within a mixed railway car configuration.

### CROSS-REFERENCE TO RELATED APPLICATIONS

This application is related to and claims priority from U.S. Provisional Patent Application Ser. No. 60/527,505 filed on Dec. 5, 2003.

### FIELD OF THE INVENTION

The present invention relates, in general, to a train communication system and, more particularly, the instant invention relates to a serial train communication system for a railway train consisting of at least one locomotive and a predetermined plurality of railway cars coupled thereto and, yet more particularly, the invention relates to a serial train communication system utilizing sound transmission and, still more particularly, the present invention relates to a serial train communication system utilizing sound transmission for controlling brakes of the railway car.

### BACKGROUND OF THE INVENTION

The following background information is provided to assist the reader to understand the environment in which the invention will typically be used. The terms used herein are not intended to be limited to any particular narrow interpretation unless specifically stated otherwise in this document.

In an attempt to improve operation of railway cars, various Railroads have been deploying and testing new systems and methods of controlling various equipment installed on such railway cars in general and, particularly, controlling main pneumatic braking systems of the railway car. The two systems that have received the most attention are an Electrically Controlled Pneumatic (EP) braking system and Electronically Controlled Pneumatic (ECP) braking system.

An EP braking system uses several train wires to operate individual valves to control brakes. While offering a direct brake release and improved air pressure consumption, most of these systems use a second train line for main reservoir air supply and they do not have built-in two-way communication capabilities. Furthermore, the EP braking system is primarily used in rapid transit urban operations and long haul passenger trains in combination with electric traction and multiple unit control.

An ECP braking system has been introduced in an attempt to overcome the drawbacks of the air brake system on long freight trains. The ECP braking system, a highly integrated braking control system, uses an electronic signal along an on-train communication network to initiate braking applications and releases. It also enables a two-way communication between components of the braking system and an onboard computer providing a train Engineer with the information on the status and condition of such components.

To apply the brakes, the Engineer utilizes the lead control unit disposed in a vicinity of the engineer's console to select the amount of desired brake cylinder pressure (or percentage of braking effort). The lead control unit codes the selected pressure and broadcasts a brake command in a data form to control units disposed in each ECP braking system on all railway cars. This brake command enables a supply of the compressed air from reservoirs to the brake cylinder in each ECP braking system until the desired cylinder pressure is achieved. A control unit continuously monitors brake cylinder pressure against leakage and maintains the desired pressure.

To enact either partial or a full brake release, the Engineer selects a new desired brake pressure level. Again, the brake command is broadcast and results in a reduction of the brake cylinder pressure within each ECP braking system. If the Engineer requires only a partial reduction of the braking effort, he can increase the braking pressure again as needed without performing a full brake release first. The control unit on each car further constantly monitors brake pipe, reservoir tank and brake cylinder pressures.

When braking commands are not being transmitted, operational status information is being broadcast between the lead and last car in the train consist and is being monitored by each railway car control unit within such train consist.

The main expected advantage of the ECP braking system is a reduced braking distance, in return allowing higher train speeds, improved fuel efficiency and improved rail system throughput. The subsequent improved train handling reduces slack action, breakaways and derailment thus potentially leading to a safer and easier train operation, reduction in maintenance of the key components, such as draft gears, and reduction in the operating crew size.

There are also several disadvantages of the current ECP braking systems causing limited application within railways.

In a first aspect, there is a significant voltage drop over an entire car freight train consist. In order to have at least 12 Volts on the last car, the first car must have at least 220 Volts resulting in a voltage drop of about 200 Volts. An additional disadvantage is the use of heavy 6 to 8 gage wire, potentially shielded from transients and other noise inducing factors.

In a second aspect, a greater brake shoe wear has been documented due to a more frequent use of the brakes.

In a third aspect, a simultaneous brake operation is required to minimize problems related to draft/buff conditions within the railway train.

In a fourth aspect, ECP braking system requires significant capital expenditures due to high implementation costs. Even though the system was first introduced in 1993, the Return On Investment (ROI) has not yet been fully realized.

Several other communication systems have their inherent disadvantages. For example, use of RF communication is impeded by problems of communication with wrong cars within or outside of its own train consist. Infrared and optical based communication systems suffer from the dirty and dusty environment degrading the operational capabilities of the infrared and optical sensor components respectively.

Additional disadvantages with electrical based communication and control systems are associated with the need to route new electrical wires, starting with the locomotive, as well as route these wires in extremely close proximity to the air brake hose. Such air brake hose, as is well known, drops low to the ground when not properly adjusted hitting the objects at the railroad crossings and thus severing air and electrical connection.

As it can be seen from the above discussion, there is a need for an improved communication system for freight railway trains requiring smaller capital expenditures and offering a more reliable operation.

### SUMMARY OF THE INVENTION

A train communication system of the present invention overcomes difficulties associated with other types of train communication systems by employing ultrasonic transmission means for transmitting and receiving a sound wave of a predetermined frequency, wherein the sound wave is associated with at least a command signal. The ultrasonic transmission means have various advantages. They are capable of detecting small objects over long operating distances. Further, ultrasonic transmission means are impervious to target materials, surface and color and such ultrasonic transmission means are resistant to external disturbances such as vibration, infrared radiation, and ambient noise and EMI radiation. Additionally, they are not affected by dust, dirt or high-moisture environments and they have a virtually unlimited maintenance-free lifespan.

The serial train communication system comprises a power source and a controller coupled to such power source. The power source is a simple battery due to the low power requirements. The controller is capable of executing a predetermined software algorithm. The controller and power source can be mounted in any place or to any apparatus of the railway car.

The ultrasonic transmission means includes a transmitter mounted at one end of the railway car or the locomotive and a receiver mounted at the opposite end of the railway car or the locomotive in alignment with the transmitter. Both the receiver and transmitter are coupled to the controller and to the power source.

A command signal from the locomotive cab causes the controller installed on the locomotive to enable its transmitter to transmit a sound wave of a predetermined frequency which is above a range of human hearing in a first direction and such sound wave is received by the receiver on the railway car producing the output signal to its controller. The controller then enables the transmitter mounted at the opposite end of the railway car to transmit the sound way in the first direction toward the next car, thus establishing a serial train communication.

The controller may also be coupled to various apparatuses disposed on the railway car, such as brakes or hand brakes, for enabling operation thereof upon receiving an output signal from the receiver.

Further, the ultrasonic transmission means includes a transceiver in combination with the transmitter and the receiver which enables transmission of the sound wave in a second direction toward the locomotive for providing an operational status feedback signal to the locomotive cab.

The transceivers are mounted within an air brake line having a plurality of air brake pipes and air brake hoses which run along the entire railway train for operation of the brake systems disposed within a wheel set of the railway car or the locomotive.

Since the train communication system is battery powered and uses non-contact ultrasonic transceivers for communication, each system is a stand alone system enabling ease of retrofit onto existing railway cars and reduction of capital expenditures associated with other types of communication systems.

### OBJECTS OF THE INVENTION

It is a primary object of the present invention to provide a serial train communication system utilizing a sound transmission means.

It is another object of the present invention to provide a serial train communication system utilizing a sound transmission means which is unaffected by environmental factors.

It is yet another object of the present invention to provide a serial train communication system utilizing a sound transmission means which enables operational control of apparatuses locally mounted on a railway car.

It is a further object of the present invention to provide a serial train communication system utilizing a sound transmission means which can be integrated with control equipment and an event recorder located in a locomotive cab.

It is yet a further object of the present invention to provide a serial train communication system utilizing a sound transmission means which has capabilities for future interface with EP and ECP braking systems.

It is additional object of the present invention to provide a serial train communication system utilizing a sound transmission means which requires reduced capital investment and expenditure.

Although a number of objects and advantages of the present invention have been described in some detail above, various additional objects and advantages of the serial train communication system of the present invention will become more readily apparent to those persons who are skilled in the art from the following more detailed description of the invention, particularly when such detailed description of the invention is taken in conjunction with both the attached drawing figures and with the appended claims.

### BRIEF DESCRIPTION OF THE DRAWINGS

FIG. 1 is a diagrammatic representation of a prior art railway train consisting of a locomotive and a plurality of railway freight cars;

FIG. 2 is a diagrammatic representation of a serial train communication system of one embodiment of the present invention showing installation of the ultrasonic sensors at each end of a railway car;

FIG. 3 is a schematic representation of a serial train communication system of FIG. 2, showing a component interface;

FIG. 4 is a diagrammatic representation of a serial train communication system of another embodiment of the present invention showing attachment of the ultrasonic transceivers at each end of the railway car and showing attachment of the controller and the power source;

FIG. 5 is a schematic representation of a serial train communication system of FIG. 4, showing a component interface and an interface with an automatic set and release hand brake; and

FIG. 6 is a diagrammatic representation of a serial train communication system of yet another embodiment of the present invention showing installation of the ultrasonic transceivers within an air brake pipe.

### DETAILED DESCRIPTION OF VARIOUS PREFERRED AND ALTERNATIVE EMBODIMENTS OF THE INVENTION

Prior to proceeding with the more detailed description of the invention it should be noted that for the sake of clarity and understanding the invention, identical components which have identical functions have been identified with identical reference numerals throughout the several views illustrated in the attached drawing Figures, unless otherwise noted.

FIG. 1 shows a railway train, generally designated 10, having at least one locomotive 12 with a cab 13 and a predetermined plurality of railway cars 14 through 18 serially coupled to such at least one locomotive 12. As can be understood, railway trains and, particularly, railway freight trains can operate many more cars than shown, and typically, one-hundred to two-hundred and fifty railway freight car trains are not uncommon. While FIG. 1 only depicts three railway cars 14-18 and one locomotive 12, it is to be understood that multiple railway cars of any length can be used in practicing the invention.

The at least one locomotive 12 and each railway freight car 14-18 is equipped with a pair of pockets 20 disposed at each end thereof. Each end pocket 20 houses a coupling means 22 for interconnecting such at least one locomotive 12 and predetermined plurality of freight railway cars 14-18 into a railway train 10. The coupling means 22 may be of any well known coupler, articulated coupling, or drawbar.

An air brake line 24 consisting of rigid pipe portions 26 and flexible hose portions 28 runs through the entire length of the railway train 10, starting with the at least one locomotive 12, for providing an air supply and a brake signal to a plurality of brake systems 30 disposed within a wheel set 29, which are well known in the art.

Each freight railway car 14 through 18 is generally provided with a hand brake 32 having a connection with the brake system 30 via a chain 34 for manually applying such brake system 30 when the railway train 10 is in a parked condition and air supply is not available to the plurality of brake systems 30.

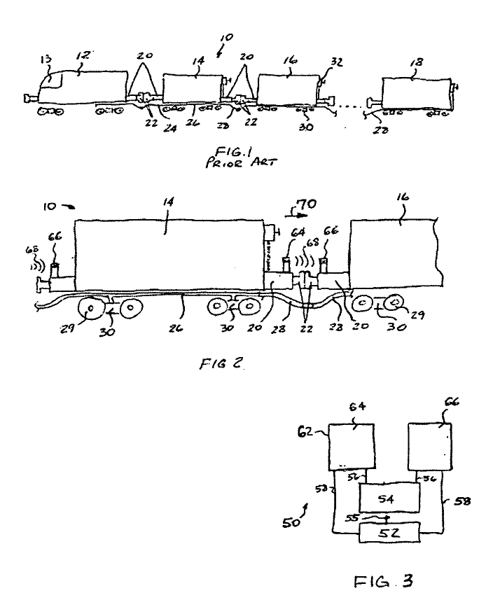

A serial train communication unit, generally designated 50, of one embodiment is best shown in FIGS. 2 and 3 and comprises a power source 52, a controller 54 electrically coupled to the power source 52 via at least one electrical connection 55, a first sound transmission means 64 rigidly attached to a first end pocket 20 and a second sound transmission means 66 rigidly attached to an opposed second end pocket 20, such second sound transmission means 66 being aligned with such first sound transmission means 64. Both the first and second sound transmission means 64 and 66 respectively are electrically coupled to the controller 54 via a pair of control wires 56 and are coupled to the power source via a pair of power wires 58. In such embodiment, the first sound transmission means 64 is preferably an ultrasonic transmitter 64 capable of transmitting a sound wave 68 of a predetermined frequency above an upper limit of a human hearing and the second sound transmission means 66 is an ultrasonic receiver 66 capable of receiving such sound wave 68.

The controller 54, preferably, is a microprocessor 54 capable of executing a predetermined software logic algorithm. A power source 52, preferably, is a simple battery due to the low power requirements of the microprocessor 54 and the ultrasonic transmitter and receiver 64 and 66 respectively. The control wires 56 are of a predetermined size, preferably in a range of 14-16 GA, since, as it well known, no significant voltage drop occurs during electrical communication between the controller 54 and the ultrasonic transmitter and receiver 64 and 66 respectively.

In reference to FIG. 2, which at least partially shows a pair of adjacent railway cars 14 and 16, the ultrasonic transmitter 64 is rigidly attached to the first end pocket 20 of each railway car 14, 16 and the ultrasonic receiver 66 is rigidly attached to the second end pocket 20 of each railway car 14, 16. As is well known, a generally fixed distance between opposed end pockets 20 enables establishing a predetermined distance between the ultrasonic transmitter 64 and the ultrasonic receiver 66.

In operation, the ultrasonic transmitter 66 mounted on the second end pocket of the first railway car 14 will receive the sound wave 68 having such predetermined frequency from the at least one locomotive 12. The ultrasonic receiver 66 will then provide an output signal to the controller 54 on the first railway car 14 via the control wire 56 where the output signal will be processed according to the predetermined software logic algorithm. The controller 54 on the first railway car 14 will enable the ultrasonic transmitter 64 mounted on the first end pocket thereof to send the sound wave 68 in a direction 70 toward the ultrasonic receiver 66 mounted on the second end pocket of the second railway car 16. The ultrasonic receiver 66 will then provide an output signal to the controller 54 on the second railway car 16 via the control wire 56 where the output signal will be processed according to the predetermined software logic algorithm. The controller 54 on the second railway car 16 will enable its own ultrasonic transmitter 64 (not shown) mounted at the opposite end thereof to transmit the sound wave 68 in the direction 70 toward the next railway car 18 thus enabling a communication within the railway train 10, which is serial in its nature.

The serial train communication unit 50 disposed within the at least one locomotive 12 is generally referred to as a lead unit and is coupled to a control equipment including but not limited to a brake control lever and an event recorder located in the locomotive cab 13 which are not shown but are well known in the art.

Advantageously, the operation of the ultrasonic transmitter 64 and the ultrasonic receiver 66 is resistant to external disturbances such as vibration, infrared radiation, ambient noise and EMI radiation and is not affected by dust, dirt or high-moisture environments. Thus, the control wires 56 will not require shielding.

It will be understood that the ultrasonic transmitter 64 and the ultrasonic receiver 66 may be mounted directly to a wall structure of the first and second railway cars 14 and 16 respectively in an alignment with each other.

Employment of a dedicated power source 52 eliminates routing of the electrical wires associated with EP and ECP braking systems thus simplifying installation effort, reducing capital expenditures and providing a more reliable operation.

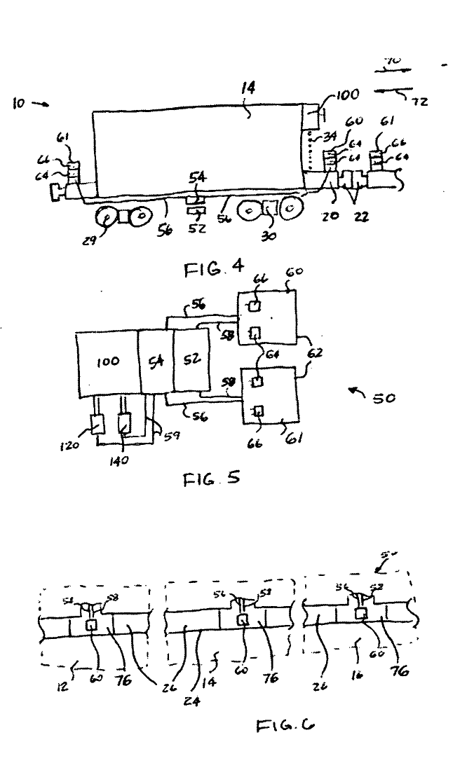

FIGS. 4 and 5 show another embodiment of the present invention, wherein a first sound transmission means 60 is a first ultrasonic transceiver rigidly attached to the first end pocket 20 of each railway car 14, 16 and a second transmission means 61 is a second ultrasonic transceiver rigidly attached to the second end pocket 20 of each railway car 14, 16 in alignment with such first sound transmission means 60 and being disposed at the predetermined distance thereto.

Each ultrasonic transceiver 60, 61 comprises the transmitter member 64, and the receiver member 66 and may include a housing 62 having a mounting means (not shown).

In operation, the transmitter member 64 of the first ultrasonic transceiver 60 mounted on the first end pocket of the railway car 14 will send the sound wave 68 having the predetermined frequency above the upper limit of human hearing in a first direction 70 toward the receiver member 66 of the second ultrasonic transceiver 61 mounted on the second end pocket of the second railway car 16. The first ultrasonic transceiver 60 will then receive and process a returned sound echo produced by the receiver member 66 in a second direction 72. The first ultrasonic transceiver 60 will then provide an output signal to the controller 54 on the first railway car 14 via the control wire 56 where the output signal will be processed according to the predetermined software logic algorithm. It will be understood that the return sound echo will be associated with the presence of such receiver member 66 and, more particularly, will be associated with presence of the railway car 16. Accordingly, the second ultrasonic transceiver 61 will send its own sound wave toward the first ultrasonic transceiver 60 in the second direction 72 receiving a feedback echo sound in the first direction 70 and providing an output signal to the controller 54 mounted on the second railway car 16. By measuring a time increment for the sound echo to return and knowing a speed of sound, each controller 54 can determine the distance between the pair of ultrasonic transceivers 60 and 61 to validate a communication therebetween, and, more importantly, to validate the communication between a pair of adjacent railway freight cars 14 and 16.

In a like manner, the controller 54 on the first railway car 14 will enable a second ultrasonic transceiver 61 mounted at the opposite end thereof to transmit the sound wave 68 in the second direction 72 toward the at least one locomotive 12. The controller 54 on the second railway car 16 will enable a first ultrasonic transceiver 60 mounted at the opposite end thereof to transmit the sound wave 68 in the first direction 70 toward the next railway car 18 thus enabling a communication within the train 10, which is serial in its nature. It will be understood that the communication in the first direction 70 will provide a command signal from the at least one locomotive 12 to each railway car 14-18, while the communication in the second direction 72 will provide an operational status feedback signal to the at least one locomotive 12.

It will be appreciated that the serial train communication unit 50 containing ultrasonic transceivers 60, 61 having both the transmitter member 64 and the receiver member 66 enables two-way communication between the at least one locomotive 12 and the predetermined plurality of the railway cars 14 through 18. Such two-way communication is advantageous, where the railway cars 14 through 18 are frequently interchanged between different trains 10 or where the status feedback signal is required for monitoring system performance from the locomotive cab 13.

In reference to FIG. 4, the controller 54 and the power source 52 are attached to an underside surface of the railway car 14 intermediate each end thereof for ease of connectivity to various apparatuses disposed thereabout.

FIGS. 4 and 5 further show an application of the serial train communication unit 50 of the present invention in combination with an Automatic Set and Release (ASR) hand brake assembly 100 taught in U.S. Pat. No. 6,709,068 entitled “Automatic Set and Release Hand Brake Pneumatic Circuit Design II/Automatic Application Function” and in U.S. Pat. No. 6,394,559 entitled “Control Apparatus for the Application and Release of a Hand Brake, both owned by the assignee of the present invention. The teachings of U.S. Pat. No. 6,709,068 and U.S. Pat. No. 6,394,559 are incorporated herein by reference thereto.

The ASR hand brake 100 is connected with the brake system 30 via a chain 34. The ASR hand brake 100 has an apply valve 110 and a release valve 130 disposed in a control circuit and electrically coupled to the controller 54 with a plurality of auxiliary control wires 59. To apply the ASR hand brake 100, the engineer issues an apply signal from the locomotive cab 13, which is communicated through the plurality of ultrasonic transceivers 60 in a manner described supra to each railway car 14 through 18. Each controller 54 upon receiving such apply signal, initiates activation of the apply valve 110 electrically coupled thereto to wind up the chain 34 and engage the brake system 30 with the wheel set 29. Accordingly, a release signal sent from the locomotive cab 13 will be received by the controller 54 to initiate the release valve 130 in order to release the chain 34 and subsequently disengage the brake system 30 from the wheel set 29.

An apply sensor 120 attached to the ASR hand brake 100 and electrically coupled to the controller 54 may be included to confirm winding of the chain 34. Accordingly, a release sensor 140 may be included to confirm release of the chain 34. Such status information may be communicated via the serial train communication unit 50 to the event recorder (not shown) located in the locomotive cab 13.

It will be appreciated that the predetermined software algorithm executed by the controller 54 will be modified to enable interface with the ASR hand brake 32. Accordingly, such predetermined software algorithm may be further modified to enable interface with other various equipment installed on the railway car, including EP and ECP braking systems.

In reference to FIG. 5, the controller 54 and the power source 52 may be rigidly attached to the ASR hand brake 100 thus further reducing installation costs and capital expenditures associated with adapting the railway car 14 for mounting of such components.

FIG. 6 illustrates yet another embodiment of the present invention wherein the ultrasonic transceiver 60 is installed within a housing 76 disposed within a portion of the brake pipe 26 enabled by, as it generally known, their relative small size. Such embodiment will be particularly advantageous in employing a single ultrasonic transceiver 60 within each railway car 14-18 and will be further advantageous in communicating within a mixed configuration of railway cars in the railway train 10, wherein only a partial quantity of railway cars is equipped with the serial train communication unit 50 of the present invention.

Those skilled in the relevant art would easily understand that the aforementioned serial train communication system is capable of controlling and monitoring operation of the brake system 30 by coupling to a control means thereof as well as controlling and monitoring other apparatuses found on a typical railway car in a manner as described supra for application of the ASR hand brake 100. The additional status information collected and communicated to the cab event recorder (not shown) may include: brake cylinder piston travel measurement, p/m worn brake shoe detection, truck derailment detection, brake pipe pressure, brake cylinder pressure, hot bearing detection/ confirmation, p/m truck/wheel set maintenance needs, and other operational parameters.

It will be further understood that ultrasonic transceivers 60, the controller 54 and the power source 52 may be mounted on any such apparatus as best suitable for a particular application.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

For example, the ultrasonic transceiver 60 may be installed within an air hose assembly 28 further reducing retrofit costs of the existing railways cars 14-18.

1. A serial train communication system for a railway train, said serial train communication system comprising:
(a) a power source;
(b) a controller coupled to said power source;
(c) a first means for transmitting a sound wave associated with a command signal provided from at least one locomotive, said sound wave having a predetermined frequency, said first means engageable with one end of one of said at least one locomotive, a railway car and a combination thereof and coupled to said power source and said controller, said controller enabling said first means to transmit said sound wave in a first direction;
(d) a second means coupled to said power source and said controller for receiving said sound wave and for providing an output signal to said controller upon receiving said sound wave, said second means engageable with an opposed end of said one of said at least one locomotive, said railway car and said combination thereof and in alignment with said first means.

2. A serial train communication system according to claim 1, wherein said predetermined frequency is greater than an upper limit of human hearing.

3. A serial train communication system according to claim 1, wherein said power source is a battery.

4. A serial train communication system according to claim 1, wherein said controller executes a predetermined software algorithm.

5. A serial train communication system according to claim 1, wherein said first means is rigidly attached in a first predetermined location at a first end pocket and said second means is rigidly attached in a second predetermined location at an opposed second end pocket.

6. A serial train communication system according to claim 1, wherein said serial train communication system controls a brake system disposed within a wheel set, said brake system having at least a control means thereof coupled to said controller, whereby a command signal received by said controller via said receiving means activates said control means and engages said brake system with said wheel set.

7. A serial train communication system according to claim 1, wherein said serial train communication system includes an automatic set and release hand brake having a chain connection with a brake system disposed within a wheel set and having at least a brake applied valve coupled to said controller, whereby a command signal received by said controller via said second receiving means enables activation of said apply valve causing said chain to wind up and engage said brake system with said wheel set.

8. A serial train communication system according to claim 7, wherein said serial train communication system further includes a release valve coupled to said controller for releasing said chain and for disengaging said brake system from said wheel set.

9. A serial train communication system for a railway train having at least one locomotive and a predetermined plurality of railway cars serially coupled to said at least one locomotive, said serial train communication system comprising a plurality of communication assemblies, each of which is installed on said at least one locomotive and on a respective railway car, said communication assembly including:
(a) a power source;
(b) a controller coupled to said power source;
(c) a first sound transmission means associated with a sound wave having a predetermined frequency, said first sound transmission means attached at one end of said railway car and said locomotive and coupled to said power source and said controller; and
(d) a second sound transmission means associated with said sound wave, said second sound transmission means attached at an opposed end of said railway car and said locomotive in alignment with said first sound transmission means, said second sound transmission means coupled to said power source and said controller.

10. A serial train communication system according to claim 9, wherein said first sound transmission means is a transmitter.

11. A serial train communication system according to claim 9, wherein said second sound transmission means is a receiver.

12. A serial train communication system according to claim 9, wherein each of said first sound transmission means and said second sound transmission means is a transceiver including in combination a transmitter and a receiver and enabling a transmission of said sound wave in a first direction from said at least one locomotive to each of said plurality of said railway cars and enabling said transmission of said sound wave in a second direction from each of said plurality of said railway cars to said at least one locomotive, said first direction is associated with a command signal initiated within said at least one locomotive and said second direction is associated with a status feedback signal.

13. A serial train communication system according to claim 9, wherein said serial train communication system further includes a housing for encasing said first sound transmission means and said second sound transmission means, said housing having means for attachment.

14. A serial train communication system for a railway train having at least one locomotive and a predetermined plurality of railway cars serially coupled to said at least one locomotive, said serial train communication system comprising:
(a) a first sound transmission means associated with a sound wave having a predetermined frequency, said first sound transmission means installed within one of a first brake pipe and a first brake hose of said at least one locomotive;
(b) a first power source disposed within said locomotive and coupled to said first sound transmission means;
(c) a first controller coupled to said first power source, to said first sound transmission means and to a control means disposed within a cab of said at least one locomotive;
(d) at least one second sound transmission means associated with said sound wave, said at least one second sound transmission means installed within one of a second brake pipe and a second brake hose of at least one of said predetermined plurality of said railway cars;
(e) at least one second power source coupled to said at least one second sound transmission means; and
(f) at least one second controller coupled to said at least one second power source and to said at least one second sound transmission means, whereby a command signal initiated by said control means and received by said first controller enables said first sound transmission means to transmit said sound wave in a first direction, said sound wave is received by said at least one second sound transmission means enabling thereof to provide at least one output signal to said at least one second controller.

15. A serial train communication system according to claim 14, wherein said controller enables said at least one second sound transmission means to transmit said sound wave in a second direction, said second direction being opposite to said first direction.
